(19) United States
(12) Patent Application Publication
(10) Pub. No.: US 2024/0402400 A1
(43) Pub. Date: Dec. 5, 2024

(54) REALIZATION OF A PERFECT LIGHT ABSORBER IN TWO-DIMENSIONAL BILAYER BY REDUCING INTERLAYER INTERACTION

(71) Applicants: Regents of the University of Minnesota, Minneapolis, MN (US); University of Notre Dame du Lac, South Bend, IN (US)

(72) Inventors: Seungjun Lee, Saint Paul, MN (US); Dongjea Seo, Minneapolis, MN (US); Sang Hyun Park, Minneapolis, MN (US); Tony Low, Woodbury, MN (US); Steven J. Koester, Edina, MN (US); Rehan Younas, Notre Dame, IN (US); Christopher Hinkle, Notre Dame, IN (US)

(21) Appl. No.: 18/733,569

(22) Filed: Jun. 4, 2024

Related U.S. Application Data
(60) Provisional application No. 63/506,266, filed on Jun. 5, 2023.

(51) Int. Cl. G02B 5/00

(52) U.S. Cl. CPC G02B 5/003

(57) ABSTRACT

Approaches to stack monolayer transition metal dichalcogenides (TMD) materials to develop near-perfect light absorbers (NPLAs) with only two atomic layers of TMD. Stacking TMDs may result in interlayer coupling with undesirable light absorbing behavior. The NPLAs of this disclosure stacks monolayer TMDs in such a way as to minimize TMD interlayer coupling, thus preserving TMD strong band nesting properties. Examples of approaches in this disclosure control the interlayer coupling by, for example, (a) twisted TMD bi-layers and (b) adding a buffer layer, e.g., a TMD/buffer layer/TMD tri-layer heterostructure. The NPLAs of this disclosure use the band nesting effect in TMDs, combined with a Salisbury screen geometry, to demonstrate NPLAs using only two or three uniform atomic layers of TMDs.

### GOVERNMENT RIGHTS

This invention was made with government support under DMR1921629, and DMR1921818 awarded by the National Science Foundation. The government has certain rights in the invention.

This application claims the benefit of U.S. Provisional Patent Application No. 63/506,266, filed 5 Jun. 2023, the entire contents of which is incorporated herein by reference.

### TECHNICAL FIELD

The disclosure relates to light absorption in optical resonators.

### BACKGROUND

Near-perfect light absorbers (NPLAs), with absorbance, A, of at least 99%, have a wide range of applications ranging from energy and sensing devices to stealth technologies and secure communications. Some examples of NPLAs have relied upon plasmonic structures or patterned metasurfaces, which require complex nanolithography, limiting their practical applications, particularly for large-area platforms.

### SUMMARY

In general, the disclosure describes example techniques to stack monolayer transition metal dichalcogenides (TMD) materials to develop near-perfect light absorbers (NPLAs). Stacking TMDs may result in interlayer coupling with undesirable light absorbing results. The NPLAs of this disclosure may include stacks of monolayer TMDs in such a way as to minimize TMD interlayer coupling, thus preserving TMD strong band nesting properties. The example techniques described in the disclosure may control the interlayer coupling by (a) twisted TMD bi-layers and/or (b) adding a buffer layer, e.g., a TMD/buffer layer/TMD tri-layer heterostructure.

In one example, the disclosure is directed to a device comprising: a stack of monolayer transition metal dichalcogenides (TMD) material comprising a first TMD monolayer arranged in the stack with a second TMD monolayer, wherein the stack of monolayer TMDs is configured to absorb light, and wherein at least one of the first TMD monolayer and the second TMD monolayer comprise a planar arrangement as a twisted bilayer with a rotation angle of the first TMD monolayer relative to the second TMD monolayer; or the first TMD monolayer and the second TMD monolayer are separated by a buffer layer.

In another example, the disclosure is directed to a method of manufacturing comprising: degassing a double sided polished (DSP) sapphire wafer; reducing, the temperature of the sapphire wafer to a growth temperature; depositing a first transition metal dichalcogenides (TMD) monolayer; confirming the first TMD monolayer; growing a buffer layer on the first TMD monolayer; and depositing a second TMD monolayer.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A is a conceptual diagram illustrating an NPLA of this disclosure.

FIG. 1B is a graph illustrating the maximum absorbance vs. the real part of the 2D optical conductivity σ′ of the 2D material with Salisbury screen.

FIGS. 2A and 2B are conceptual diagrams illustrating an example of adding a buffer layer to create a TMD/buffer layer/TMD tri-layer heterostructure.

FIGS. 3A, 3B and 3C are conceptual diagrams illustrating the twisted TMD bilayer approach of this disclosure.

FIGS. 4A, 4B, 4C and 4D illustrate the degradation of band nesting caused by the interlayer coupling between the TMD layers.

FIGS. 5A-5E illustrate the optical absorption of the approaches of this disclosure.

FIGS. 6A-6C illustrate an example realization of near-perfect light absorbers using the Salisbury screen and 2D material of this disclosure.

FIGS. 7A-7C illustrate near-perfect light absorbers over a wide frequency by using various TMD materials.

FIG. 8 is a flow chart illustrating a method of manufacture for the optical resonator of this disclosure.

### DETAILED DESCRIPTION

The disclosure describes example techniques to stack monolayer transition metal dichalcogenides (TMD) materials to develop near-perfect light absorbers (NPLAs). The NPLAs of this disclosure may include stacks of monolayer TMDs in such a way as to minimize TMD interlayer coupling, thus preserving TMD strong band nesting properties. As described in more detail, the example techniques may control the interlayer coupling by (a) twisted TMD bi-layers and (b) adding a buffer layer, e.g., a TMD/buffer layer/TMD tri-layer heterostructure.

MoS₂ is one example TMD material for atomically thin perfect absorbers due to the high oscillator strength of its excitonic transitions and excellent band nesting. As MoS₂ is thinned from multilayer to monolayer, the magnitude and energy of MoS₂ optical conductivity may show attenuation in magnitude and manifested by a gradual blueshift in energy with decreasing layer number due to interlayer orbital hybridization. The intrinsically poor light absorption of monolayer MoS₂, which varies by about 12% in visible spectral range, may induce the weak light-matter interaction.

As described in this disclosure, the addition of a buffer layer, such as graphene, in the intermediate layer may reduce the interlayer interaction of MoS with each other e.g., a MoS₂/graphene/MoS₂ (MGM) heterostructure. Such an MGM structure may result in a doubling effect of light absorption. Based on this MGM structure, an additional insertion of a mirror layer between the dielectric layer and the substrate, such as silver (Ag), may enhance the optical absorption, resulting from Fabry-Perot cavity reflection. The interband absorption of MGM heterostructure may be maximized by the cavity resonance and may reach the near-perfect absorption for frequencies satisfying the cavity resonance condition. The techniques of this disclosure may achieve similar results with the twisted TMD bi-layers approach.

The NPLAs of this disclosure may use the band nesting effect in TMDs, combined with a Salisbury screen geometry, to demonstrate NPLAs using only two or three uniform atomic layers of TMDs. The resulting NPLAs, verified using theoretical calculations and experimental testing, may demonstrate room-temperature values of A=95% at 2=2.8 eV with theoretically predicted values as high as 99%. Moreover, the chemical variety of TMDs allows NPLA designs covering the entire visible range, paving the way for efficient atomically-thin optoelectronics.

Selecting various 2D materials and optimization strategies, the NPLA designs may realize ideal absorption over the wide frequency range from UV to IR. The techniques of this disclosure point to a new opportunities to combine 2D heterostructure with cavity optics to enable novel device applications such as high-efficiency solar cells with nanometer-scale thickness.

The techniques of this disclosure may provide advantages over other NPLA arrangements. For example, other examples of NPLAs have relied upon plasmonic structures or patterned metasurfaces, which require complex nanolithography and expensive fabrication costs, limiting their practical applications, particularly for large-area platforms. Other example approaches may increase the thickness of the 2D layers. In addition, critical coupling may be an effective method for achieving perfect optical absorption. However, critical coupling may require an intricate balance between absorption rate of the active layer and the leakage of the cavity mode. Design parameters which rely on fabrication precision may prove difficult to tune, since critical coupling occurs only along a precise design parameter contour. For semiconductors or semimetals such as graphene, active electrical tunability of optical properties may be achieved via their Drude conductivity, albeit only across the terahertz or mid-infrared regime. On the other hand, an electrically tunable active layer in the visible regime for critical coupling may be a challenge.

In contrast, the techniques of this disclosure may produce NPLAs for large and small platforms that function over a wide frequency range. The use of the 2D TMD layers of this disclosure may use a much simpler device structure. For instance, 2D layers of TMDs, combined with conventional metal reflectors, such as Au or Ag, as used in the structures of this disclosure may exhibit near-perfect light absorption without the use of additional layers and without the need for complex patterned structures that may be found in other examples of light absorption structures. For example, the TMD structure of this disclosure may be included in an optical resonator structure such as a Salisbury screen, which may include a dielectric spacer and a metal reflector. The techniques of this disclosure may further resolve the issues of controllably growing such multilayer TMDs, and the ability to tune peak absorption wavelength of the TMD, which in previous attempts may have been severely limited.

The techniques of this disclosure include an approach based upon “band nesting” that allows NPLAs to be achieved in only two or three layers. In the example of monolayer TMDs used for optical absorption, the monolayer TMDs may benefit from an unusually strong band nesting effect leading to optical conductivity of ˜1 milli-Siemens (mS). This is roughly 10× higher than the value of graphene across the visible spectrum. If the optical constant scales linearly with the number of layers, then the ultimate TMD thickness for NPLAs with the Salisbury screen may be just two atomic layers. However, the band nesting effect may be disrupted by electronic coupling between layers. In this disclosure, both twisted two-layer (2L) MoS₂ and three-layer (3L) MGM heterostructures may effectively alleviate the interlayer coupling, allowing for the observation of substantial absorption (A) enhancement up to 95%, but with the theoretical potential of A up to 99%. The same strategy, in principle, may be combined with other 2D materials to realize NPLAs covering the entire visible light range, which paves the way for practical applications of future atomically thin optoelectronics. This disclosure also demonstrates a viable pathway where the proposed TMD/buffer layer/TMD heterostructure may be grown in-situ over large area with no mechanical exfoliation and transfer. In this disclosure, a two-layer structure in which both layers are of the same material may be referred to as a homobilayer, e.g., MoS₂-MoS₂ or WSc₂-WSc₂. In contrast a heterobilayer is a two-layer structure with different materials, e.g., MoS₂-WSc₂.

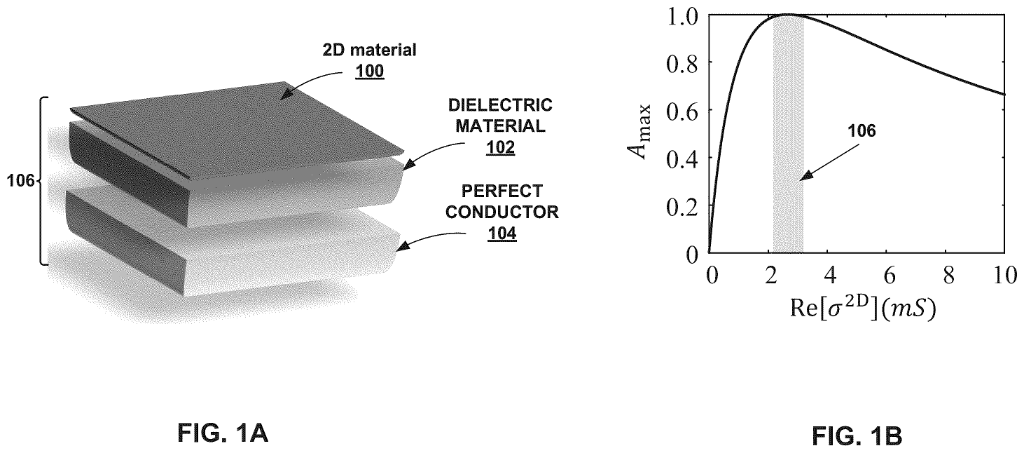

FIG. 1A is a conceptual diagram illustrating an NPLA of this disclosure. The example of FIG. 1A includes a Salisbury screen 106 with a dielectric spacer, dielectric material 102 and a metal reflector, e.g., perfect conductor 104. As noted above, the reflector may be one of any variety of materials including silver (Ag), gold (Au) and other similar materials. In some examples, dielectric material 102 may include silicon dioxide (SiO₂) or other dielectric material. Two-dimensional material, 2D material 100, may be a multi-layer TMD material of this disclosure. As noted above, 2D material 100 may include a bilayer structure in which one layer is rotated with respect to the other layer. In other examples, 2D material 100 may be arranged as a three-layer MGM structure with a buffer layer between TMD layers. The multi-layer 2D material 100 of this disclosure may also be described as a stack of monolayer TMD materials, where a first TMD monolayer and a second TMD monolayer of the stack of monolayer TMD materials are each two-dimensional (2D) materials. A 2D material may be a material where the thickness of the material is a minimum thickness of a chemical structure of a combination of elements that form the (e.g., where thinning the material past the minimum thickness results in changing the chemical structure of the material). For example, a stack of TMD monolayers may include a first TMD monolayer and a second TMD monolayer, where a thickness of the first TMD monolayer is a minimum thickness of a chemical structure of a combination of elements that form the first TMD monolayer, and where a thickness of the second TMD monolayer is a minimum thickness of a chemical structure of a combination of elements that form the second TMD monolayer. Additionally, or alternatively, the thickness of a 2D material such as a TMD monolayer may be a minimum thickness where the molecules of the TMD monolayer are covalent bonded. For example, a stack of TMD monolayers may include a first TMD monolayer and a second TMD monolayer, where a thickness of the first TMD monolayer is a minimum thickness where the molecules of the first TMD monolayer are covalent bonded, and where a thickness of the second TMD monolayer is a minimum thickness where the molecules of the second TMD monolayer are covalent bonded. This disclosure describes properties and comparisons of both monolayer materials (1L) as well as the multi-layer 2D material 100, e.g., 2L and 3L. In this disclosure, a “bilayer” indicates a two-layer TMD structure, e.g., 2L TMD.

FIG. 1B is a graph illustrating the maximum absorbance vs. the real part of the 2D optical conductivity σ′ of the 2D material with Salisbury screen. The gray shaded area 106 highlights ideal absorption conditions, e.g., absorbance, A, greater than 99% with Salisbury screen where σ′ ranges from 2.17 mS to 3.24 mS.

The techniques of this disclosure may stem from NPLA design based on 2D materials. Between two dielectric media, the value of A for a material having a complex 2D optical conductivity of σ_{2D}(ω)=σ′(ω)+iσ″(ω) may be derived by transfer matrix method such as shown in the equation below:

$$A ( ω ) = \frac{4 {n}_{1} {σ}^{′} ( ω ) {Z}_{V A C}}{{\vert {n}_{1} + {n}_{2} + {σ}_{2 D} ( ω ) {Z}_{V A C} \vert}^{2}} \qquad [ 1 ]$$

where n1 and n2 are the refractive indexes on top and bottom sides of the 2D material, and Z_{VAC}=376.73 Ω=1/ϵ₀c is the impedance of vacuum. Since the maximum of σ′ coincides with a zero of σ″ due to the Kramers-Kronig relations, in the freestanding case (n1=n2=1) the maximum A of a 2D material may be simplified as a function of σ′. Without any optical cavity, the maximum A of a freestanding 2D layer may be limited up to 0.5 when σ′=2ϵ₀c.

To improve A beyond the freestanding limit, resonators may be useful to improve A. Instead of using a complex structure, the techniques of this disclosure consider another example of an optical resonator, which may include the Salisbury screen as including a dielectric spacer and metal reflector. Similar to a freestanding 2D material, the value of A of the Salisbury screen may be calculated by the transfer matrix method. The transfer matrix method (TMM) may be used as a mathematical method for determining reflection and transmission characteristics of, for example, electromagnetic waves in multi-layered slabs of material.

When the dielectric spacer thickness is optimized, the maximum A of the Salisbury screen may be described as the equation below, which is plotted in FIG. 1B:

$$A ( ω ) = 1 - \frac{{( 1 - {σ}^{′} ( ω ) {Z}_{V A C} )}^{2}}{{( 1 + {σ}^{′} ( ω ) {Z}_{V A C} )}^{2}} \qquad [ 2 ]$$

With the structure of equation 2, A may approach 100% when σ′=ϵ₀c. The values of σ′ may include an optimal range to realize NPLA. For example, when σ′ (A) of a freestanding 2D material ranges from σ′=2.17 mS (41.2%) to σ′=3.24 mS (47.1%,) then using a single mirror structure may result in A>99%. Thus, 2D materials with these target conductivities may allow the realization of a near-ideal Salisbury screen.

In order to achieve an active layer for critical coupling in the visible regime, a Salisbury screen setup may achieve two attributes within. First, the layer may be atomically thin, with a thickness much smaller than the electronic screening length normal to the atomic plane to allow for active tunability. Second, the layer may require optical conductivity to be of order 1 mS. The latter condition may provide the reason that single-layer graphene may not work, since the optical conductivity of a single-layer graphene is two orders of magnitude smaller. 2D transition metal dichalcogenides (TMDs) may provide better choices for this application, which can have much higher optical conductivity at certain wavelengths due to an effect known as band nesting, where states from a sizable region of the Brillouin zone participate in optical transitions. Even with band nesting, single-layer TMDs may provide still slightly too-low optical conductivity, but addition of a second layer may disrupt the band nesting due to interlayer coupling that causes band hybridization.

Layering of TMDs may overcome the limitation of TMDs (e.g., individual layers) through the use of heterostructure engineering. TMD bilayers or TMD/buffer layer/TMD heterostructures may both suppress interlayer coupling, allowing the necessary optical conductivity to achieved via band nesting. These structures may achieve, absorbance as high as 95% or greater, a value close the theoretically-predicted value of 99%. In some examples, these structures may be fabricated heterostructures on a Salisbury screen reflector.

In additional examples, these structures may include multiple TMD monolayers and/or stacks of TMD bilayers and/or stacks of TMD/buffer layer/TMD heterostructures. For instance, for case of description examples are described with respect to a first TMD monolayer and a second TMD monolayer. However, the stack of monolayer TMD material may include more than the first TMD monolayer and the second TMD monolayer. For example, the stack of monolayer TMD material may include a first TMD monolayer arranged in the stack with at least a second TMD monolayer (e.g., the second TMD monolayer, and optionally may be a third, may be a fourth, may be a fifth, etc. TMD monolayers). In examples where there are more than two TMD monolayers, there may be a buffer layer between each, but the techniques are not so limited. Also, in examples where there are more than two TMD monolayers, one or more, including each, TMD monolayer may be twisted relative to another TMD monolayer in the stack, but the techniques are not so limited.

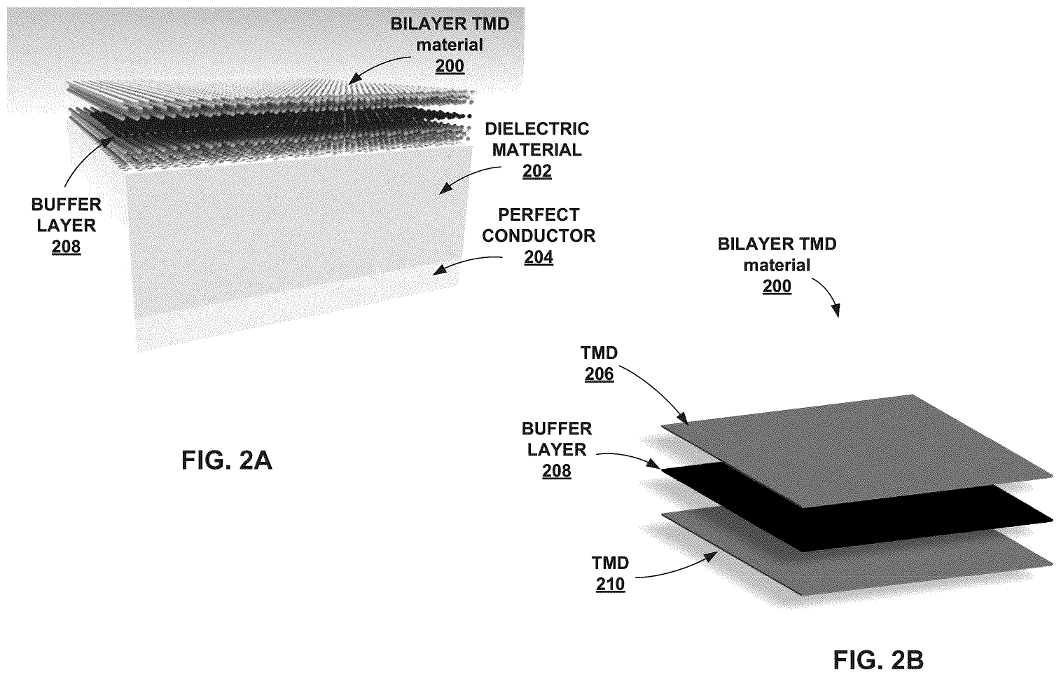

FIGS. 2A and 2B are conceptual diagrams illustrating an example of adding a buffer layer to create a TMD/buffer layer/TMD tri-layer heterostructure. That is, in the example of FIGS. 2A and 2B there are two TMD monolayers (e.g., TMD bilayers, referred to as a “bilayer” or “stack” throughout to indicate the presence of two or more layers of TMD monolayers) and a buffer layer. Hence, the stack of monolayer TMD material includes a first TMD monolayer and a second TMD monolayer that are separated by a buffer layer.

Similar to FIG. 1A, FIG. 2A is an example optical resonator structure implemented as a Salisbury screen, with a dielectric spacer, dielectric material 202, and a metal reflector, perfect conductor 204. Buffer layer 208 is located between Bilayer TMD material 200.

FIG. 2B is another view of Bilayer TMD material 200 with buffer layer 208. Bilayer TMD material 200 includes two TMD monolayers (hence the term “bilayer”, alternatively referred to as a “stack” of TMD materials or TMD monolayers throughout) and a buffer layer. In some examples, TMD 206 and TMD 210 may be MoS₂ or some other TMD material. Buffer layer 208 may include one or more materials of relatively low optical absorption and/or activity (e.g., materials with low optical absorption rates) or relatively low two-dimensional optical conductivity (e.g., optical conductivity of bilayer TMD material 200). For example, buffer layer 208 may be comprised of one or more materials that are less optically active than bilayer TMD material 200. Further, buffer layer 208 may be selected as being optically inactive and/or having relatively low optical absorption at an optical wavelength or optical wavelength range at which the stack of monolayer TMDs is configured to absorb light. For example, bilayer TMD material 200 may have a two-dimensional optical conductivity lower than 0.1 milli-siemens (e.g., 0.06 milli-siemens).

Buffer layer 208 may include materials such as graphene, zinc selenide, and/or hexagonal boron nitride. In additional examples, buffer layer 208 may be an air gap between TMD 206 and TMD 210. The TMD layers and the buffer layer are arranged in parallel planes, as shown in FIG. 2B, but the techniques are not limited to parallel planes. The TMD stack may include a dielectric spacer and a reflective mirror arranged with the stack of monolayer TMDs in a Salisbury screen configuration. For example, the TMD stack may include the dielectric spacer and reflective mirror located between and/or exterior to one or more of the TMD layers.

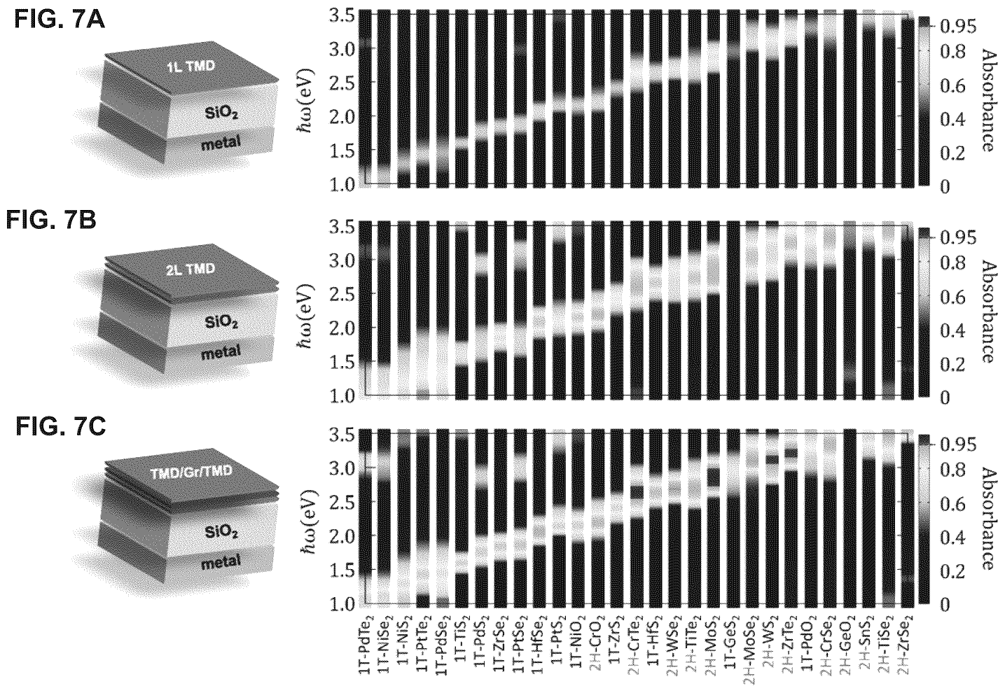

Selecting materials with high optical conductivity may be useful when designing a NPLA. Graphene may a universal optical conductivity of σ′=e²/4ℏ=0.061 mS (A˜2.3%) in the visible range due to its unique linear Dirac dispersion. Therefore, graphene by itself may not be a suitable material for NPLA because its optical conductivity is an order of magnitude smaller than that required for the ultimate Salisbury screen. Among the family of 2D materials, TMDs may exhibit strong light absorption due to its excellent nesting of electronic bands, which allows optical absorption over a broad region of the Brillouin zone at a specific wavelength. This disclosure includes surveys of the σ′ value of the family of TMD monolayers which may have finite bandgap and negative formation energy, by first-principles calculations based on density functional theory (DFT), shown for example in FIGS. 7A, 7B and 7C. Among these TMD materials, the 2H phase of MoS₂ and SnSe₂ may exhibit high σ′ of around 1 mS, which may be significantly larger than that of graphene. However, these TMD materials may be still lower than the theoretical target for the theoretical Salisbury screen (e.g., 2.17 mS<6′<3.24 mS). In one or more examples, the realization of NPLA with TMD may function with more than one layer, and possibly but not required to be better than with one TMD monolayer. As described above, adding buffer 208 between layers of TMD material may effectively alleviate the interlayer coupling, and allow for substantial absorption enhancement. In some examples the three-layer (3L) MoS₂/graphene/MoS₂ heterostructures may result in absorption enhancement of 95-99%, which is a significant improvement over TMD layers alone or graphene alone. The TMD monolayers may include materials of a minimum thickness. For example, the thickness of the first TMD monolayer or the second TMD monolayer may be such that the molecules of the first TMD monolayer or the second TMD monolayer are covalent bonded, respectively.

Bilayer TMD material 200 may absorb light having a particular optical wavelength and/or range of optical wavelengths. Bilayer TMD material 200 may be configured to absorb the light at the particular optical wavelength/range of wavelengths. Bilayer TMD material 200 may absorb light within a range of wavelengths from 100 nm to 1 mm (e.g., from near-UV to near-infrared light). For example, Bilayer TMD material 200 may absorb light at a wavelength of 350 nm. Bilayer material 200, when configured to absorb light at the particular optical wavelength/range of wavelengths, may include TMD 206 and TMD 210 separated by buffer layer 208 by a distance substantially less than the wavelength/range of wavelengths. Buffer layer 208 may separate TMD 206 and TMD 210 by the distance that is substantially less than the target optical wavelength. For example, buffer layer 208 may separate TMD 206 and TMD 210 by less than one-hundredth of a target optical wavelength. In addition, buffer layer 208 may separate TMD 206 and TMD 210 by a distance of less than or equal to 0.01 micron.

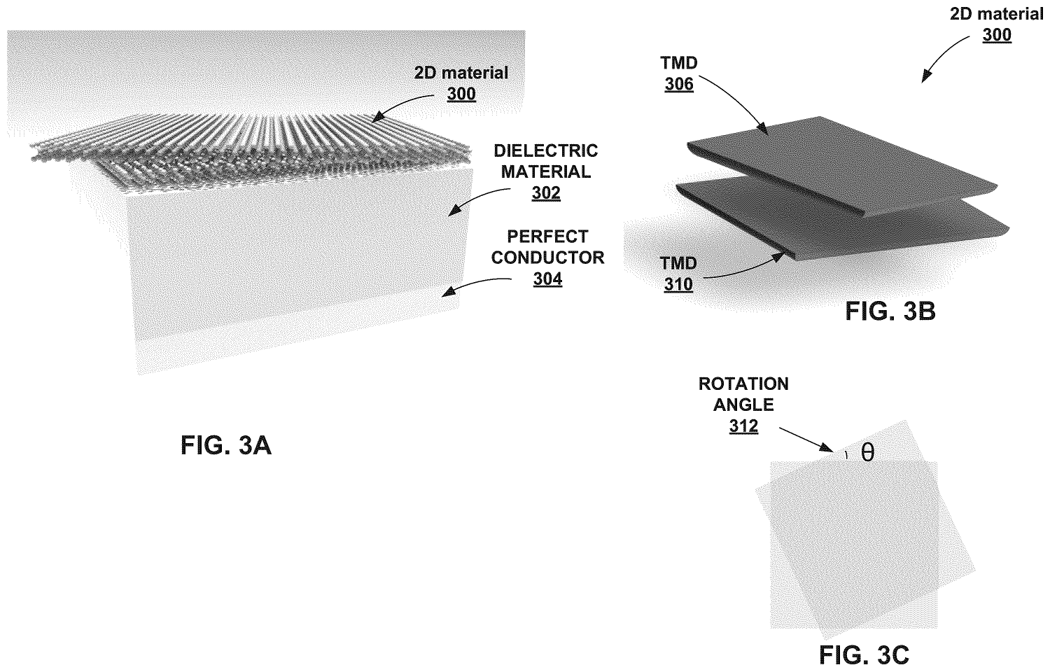

FIGS. 3A, 3B and 3C are conceptual diagrams illustrating the twisted TMD bilayer approach of this disclosure. Similar to FIGS. 1A and 2A, FIG. 3A is an example optical resonator structure implemented as a Salisbury screen, with a dielectric spacer, dielectric material 202, and a metal reflector, perfect conductor 204. 2D material 300 is implemented as two TMD layers arranged with a twist between the layers. Similar to the buffer layer, the twisted layer approach may reduce the band nesting region between the monolayers. In other words, as described above in relation to FIGS. 2A and 2B, the arrangement of the first TMD monolayer and the second TMD monolayer may alleviate interlayer coupling between the first TMD monolayer and the second TMD monolayer. Like adding the buffer layer, the arrangement illustrated in FIGS. 3A-3C may control the interlayer coupling to weaken or reduce the interlayer coupling, e.g., to alleviate the interlayer coupling.

FIG. 3B illustrates another view of the twisted bilayer structure. TMD layer 306 is oriented at an angle with respect to TMD layer 310. As shown in the example of FIG. 3C, the angle between the TMD layers is called rotation angle 312. The TMD monolayers may be in a parallel planar arrangement as twisted bilayer with a rotation angle 312 of the first TMD monolayer 306 relative to the second TMD monolayer 310. Experimental and theoretical result show that a rotation angle of approximately 30 degrees, when arranged with the Salisbury screen shown in FIGS. 1A and 3A, may result in a NPLA with limited interlayer coupling. In the homo-bilayer, twist-angle may increase interlayer distance and thus decrease interlayer interaction. The calculated absorbance may be optimum when twist-angle is around 30° because an interlayer angle near 30° may maximize interlayer distance.

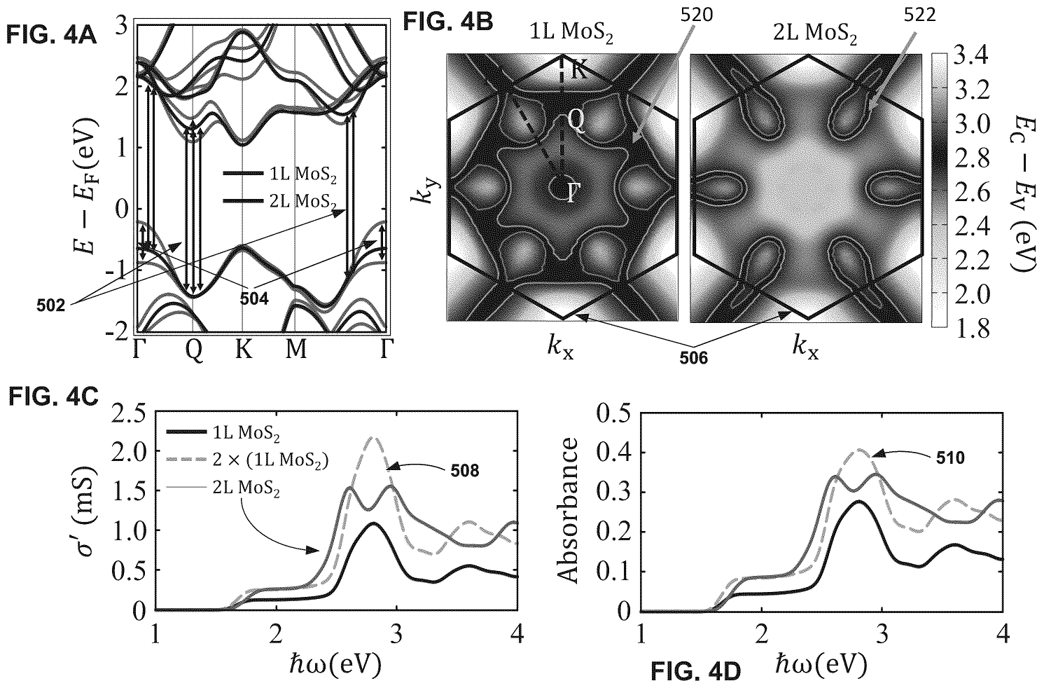

FIGS. 4A, 4B, 4C and 4D illustrate the degradation of band nesting caused by the interlayer coupling between the TMD layers. The techniques of this disclosure, e.g., two approaches may reduce interlayer coupling: (1) layer twisting and (2) inserting a buffer layer between the top and bottom TMD layers.

FIG. 4A is a graph illustrating electronic band structures compared between a 1L, single layer TMD structure and a 2L, bilayer TMD structure. In the example of FIG. 4A the TMD material is MoS₂. FIG. 4B illustrates momentum-resolved band nesting map comparison of 1L and 2L structures. FIG. 4C illustrates the real part (not complex) of 2D optical conductivities. FIG. 4D illustrates absorbances of freestanding mono and bilayer MoS₂.

In FIG. 4A, arrows 502 highlight excellent band nesting of monolayer MoS₂, whereas arrows 504 show the destruction of the band nesting in the bilayer due to the interlayer coupling. In FIG. 4B, the contour map indicates the energy difference between the energy of the lowest conduction, E_{C}, and the highest valence band, Eᵥ, and the solid lines 506 show the first Brillouin zone. In FIGS. 4C and 4D, a dashed lines 508 and 510 indicate an artificial bilayer structure having no interlayer coupling.

FIG. 4A shows the calculated electronic structures of both 1L and 2L MoS₂. Due to the excellent band nesting near the I and Q valleys (arrows 502), 1L MoS₂ may exhibit strong light absorption near 2.81 eV, in this example, where the absorption peak at this energy may be referred to as the C exciton. In the 2L MoS₂, however, interlayer coupling may split the energies at the I′ valley of the valence band and the Q valley of the conduction band (arrows 504), distorting and degrading the degree of band nesting.

To visualize the relation between interlayer coupling and band nesting more clearly, FIG. 4B represents the momentum-resolved energy difference between the highest valence bands and lowest conduction bands. In addition to the states along the high symmetry line, band nesting of 1L MoS₂ may occur over a large area of the first Brillouin zone, as shown by the dark region 520. In 2L MoS₂, however, the dark region 522 may noticeably shrink compared to 520, as interlayer coupling induces bonding and anti-bonding states between two layers, resulting in the degradation of the band nesting.

Based on the electronic structures, the graphs of FIGS. 4C and 4D, respectively, depict calculated σ′ and A of both 1L and 2L MoS₂. Because of the strong band nesting, 1L MoS₂ may exhibit a clear single peak near 2.81 eV, and the calculated values of σ′ and A may approach 1.09 mS and 27.7%, respectively. If the optical constant scales linearly with the number of layers, σ′ of 2L MoS₂ may be twice that of 1L MoS₂ (dashed lines 508 and 510 in FIGS. 4C and 4D), which satisfies the requirement for NPLA, e.g., (σ′>2.17 mS. However, in 2L MoS₂, the resonance peak due to band nesting may split into two smaller peaks and lead to maximum values of σ′=1.55 mS and A=34%, which is much lower than the target value.

FIG. 4D does not contain the A and B excitons of MoS₂ because these calculations consider only single particle transitions. Excitonic effects may be incorporated through the Bethe-Salpeter equation, and these calculations may be performed for 2L MoS₂ structures of varying interlayer distances. The examples of FIGS. 4A-4D, also show the degradation of absorption, A, with smaller interlayer distance. However, except for the one appearance of new A and B exciton features, the C exciton peak may only be slightly red-shifted compared to its single-particle peak due to interband transitions. A sharper linewidth may accompany the C exciton, though it is sensitive to the excitonic lifetimes in these calculations. More computationally efficient ingle-particle calculations may suffice for the purposes of this disclose once the C exciton serves to enhance this major peak responsible for the NPLA.

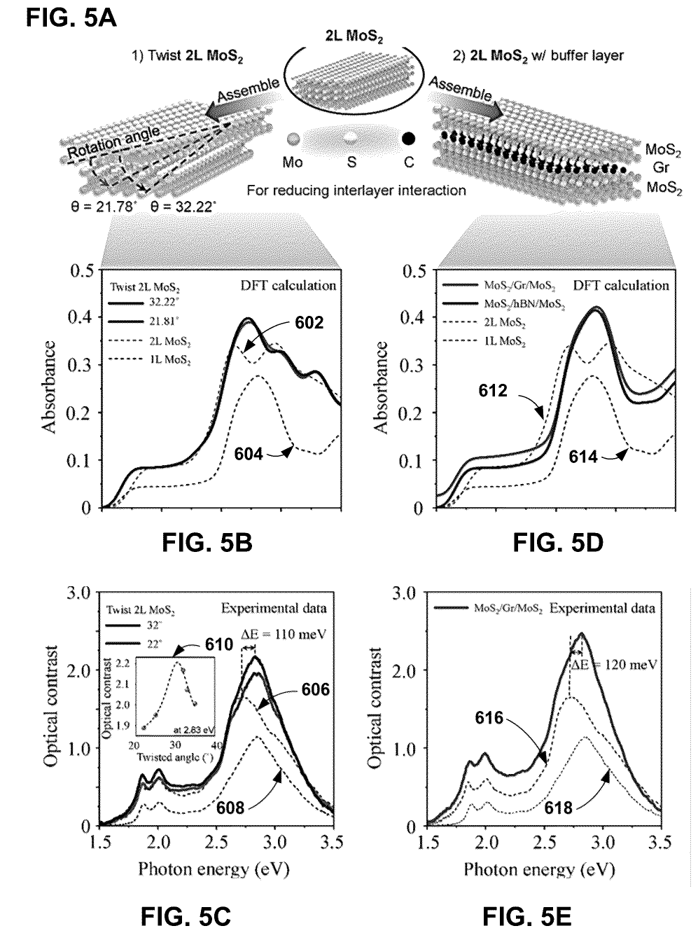

FIGS. 5A-5E illustrate the optical absorption of the approaches of this disclosure FIG. 5A is a conceptual diagram illustrating the absorption enhancement strategies of this disclosure, including the layer twisting, and inserting a buffer layer between the top and bottom layers. The different spheres may indicate examples of molybdenum, sulfur, and carbon atoms.

The example of FIG. 5A illustrates a stack of TMD material that comprises a first TMD monolayer arranged in the stack with a second TMD. The stack of TMD material may be configured to absorb light. In addition, at least one of the first TMD monolayer and the second TMD monolayer comprise a planar arrangement as a twisted bilayer with a rotation angle of the first TMD monolayer relative to the second TMD monolayer (e.g., as illustrated in FIGS. 3A-3C), or the first TMD monolayer and the second TMD monolayer are separated by a buffer layer (e.g., as illustrated in FIGS. 2A and 2B). For example, a fabricator may fabricate the stack of TMD layers as including a buffer layer such as an air gap, graphene, and/or other materials. The fabricator may fabricate the stack of monolayer TMDs as configured to absorb light with a light absorption greater than 90%. In addition, the fabricator may fabricate first and second TMD layers as being in parallel to each other.

FIGS. 5B and 5C are graphs that, respectively, illustrate the theoretically calculated absorbances and experimentally measured optical contrast of twisted 2L MoS₂. In FIGS. 5B and 5C, dashed curves 602 and 606 show spectra of 1L MoS₂, while dashed curves 604 and 608 show spectra of 2L MoS₂. In FIG. 5C, inset 610 shows the angle-dependent optical contrast of twisted 2L MoS₂ near the 30° twisted angle.

Similarly, FIGS. 5D and 5E are graphs that illustrate the theoretically calculated absorbances and experimentally measured optical contrast of 2L MoS₂ with an intermediate buffer layer. In FIGS. 5D and 5E, dashed curves 612 and 616 show spectra of 1L MoS₂, while dashed curves 614 and 618 show spectra of 2L MoS₂.

As described above in relation to FIGS. 1A-3C, to understand how to improve σ′ in MoS₂ bilayers, this disclosure describes examples to reduce interlayer coupling, such as by: (1) layer twisting and (2) inserting a buffer layer between the top and bottom layers, depicted in FIG. 5A. In van der Waals (vdW) materials, the ground state stacking configuration may have the minimum interlayer distance. Therefore, a finite twist angle may lead to a larger interlayer distance and a weaker interlayer coupling. In TMDs, the interlayer distance may be minimized at 0° and 60° twist angles but maximized near 30° due to the repulsion of the outermost chalcogen atoms. FIG. 5B illustrates the theoretical measurements including calculations for absorption, A, of freestanding twisted 2L MoS₂ with 21.81° and 32.22° twist angles. In this disclosure the twist angle is the same as the rotation angle, as described above in relation to FIG. 3C. Theoretical calculations may show maximum A of a freestanding twisted 2L MoS₂ as approaching 39% and 40% with 21.81° and 32.22° twist angles, respectively, which may be much higher than that of the value of 34% in the untwisted case described above in relation to FIG. 4D. This result may illustrate a positive correlation between band nesting and interlayer distance. Moreover, the single peak absorption in twisted bilayers may be restored and suggest reduced interlayer coupling.

Lab testing may confirm the theoretical predictions. The lab testing may include optical measurements using a microreflectance setup, such as illuminating a selective sample area with a halogen white light source. The lab testing may include obtaining large-scale and high-quality 1L MoS₂ by an Au-assisted exfoliation. Before exploring twist effects, the lab tests may first measure optical contrasts of 1L and 2L of MoS₂, which may be directly proportional to the A of the film when using a transparent substrate. The lab may define the optical contrast as (R−R₀)/R₀ where R is the reflectance of the 2D material on the substrate and R₀ is the reflectance of the bare substrate. The lab testing may show the three excitonic peaks of MoS₂ as corresponding to the A, B and C excitons, which may confirm the operation of the lab setup and the high-quality of the samples. Also, a clear redshift of the C exciton peak in the 2L MoS₂ may show evidence of the interlayer coupling.

The twisted 2L MoS₂ structures may be fabricated using a standard dry-transfer polypropylene carbonate (PCC) stamp. To precisely control the twist angle, a fabricator may pick up the MoS₂ flakes from the pre-patterned single crystal MoS₂ on a glass substrate and stack them to prepare the twisted bilayer. The optical contrasts of 2L MoS₂ with twist angles of 22 and 32° are shown in FIG. 5C, which agrees with the theoretical calculations. When the twist angle goes from 0 to 32°, the peak position of the C exciton may move from 2.71 eV to 2.82 eV, corresponding to a blueshift of 110 meV, indicating reduced interlayer coupling. Moreover, the optical contrast may maximize near 30° twist angle and tend to decrease as the twist angle moves away from approximately 30°, which may support a theoretical relationship between the interlayer coupling and the twist angle.

As described above in relation to FIGS. 1A, 1B and 3A-3C, a buffer layer inserted between the TMD layer, as shown in FIG. 5A, may minimize interlayer coupling. FIG. 5A shows the results of theoretical calculations, using either 1L graphene (Gr) or hexagonal boron nitride (hBN) as a buffer layer. FIG. 5A shows the calculated A value of MoS₂/hBN/MoS₂ and MoS₂/Gr/MoS₂ heterostructures. In contrast to 2L MoS₂, an observer may observe a single C exciton peak in both MoS₂/hBN/MoS₂ and MoS₂/Gr/MoS₂ heterostructures, implying that the band nesting of the MoS₂ layers is preserved. The observer may calculate both A of MoS₂/hBN/MoS₂ and MoS₂/Gr/MoS₂ as having A values (41.4% and 42.0%, respectively), which may not be only higher than twisted 2L MoS₂ but also the near-perfect absorption condition of A=41.2%. Also, the calculations may confirm that both MoS₂/hBN/MoS₂ and MoS₂/Gr/MoS₂ have almost exactly 2× optical conductivity of 1L MoS₂, implying effective suppression of interlayer coupling.

However, achieving critical coupling, which may lead to “perfect absorption” (>99.9%), may utilize electrical tuning, in some examples. Electrically tunable heterostructures may, through one or more techniques, achieve >99.9% absorption. For example, a twisted TMD bilayer (e.g., TMD 306 and TMD 310 of FIG. 3B) may be sandwiched between top and bottom graphene electrodes. The graphene may provide a vertical electrical field which allows for modulation of the on-site electrostatic energy of the TMD layers, which in turn may control the band nesting resonance energy. Such active tunability of the optical conductivity in the visible regime may be impossible with conventional Drude response. Critical coupling may be achieved with precise tuning of the electric field, across a finite bandwidth in the visible range, and over an angular cone of incident radiation. The TMD layers, when electrically biased, may enable management (e.g., modification) of carrier concentration of the TMD layers. In an example, a first TMD layer of the TMD bilayer is electrically biased. The first TMD layer experiences a change in the carrier concentration. As a result of the change in carrier concentration, the TMD bilayer provides a changed level of optical absorption.

Biasing of one or more of the TMD layers may enable compensation for changes in ambient temperature and/or temperature of the TMD bilayer. Changes in ambient temperature and/or temperature of the TMD bilayer may cause the TMD bilayer to provide different (e.g., reduced) levels of optical absorption. For example, an increase in temperature from a first temperature to room temperature may cause a TMD bilayer to provide reduced optical absorption. Biasing one or more TMD layers of the TMD bilayer may enable compensation for changes in temperature. In an example, the temperature of the TMD bilayer increases due to a change in ambient temperature and provides reduced optical absorption. The TMD bilayer receives an electrical signal that electrically biases one of the TMD layers. The TMD bilayer experiences a change in carrier concentration and provides increased optical absorption.

Similar to the twisted case, in some examples, a fabricator may fabricate the MoS₂/Gr/MoS₂ heterostructure by a three-step transfer process. An observer may perform optical reflectance measurements, and the results are shown in FIG. 5E. For this heterostructure, A may slightly increase due to the small but finite absorption of Gr while the excitonic peak positions remain unchanged compared to those of MoS₂ due to weak interlayer interaction. An observer may further confirm the value of A by the E¹_{2g} and A_{1g} modes of Raman spectra. The observer may observe that the optical contrast of the C exciton in the MoS₂/Gr/MoS₂ heterostructure may be enhanced by 116% and 48% compared to those of 1L and 2L MoS₂, and the redshift may not be observed. The observer may determine that all these observations are in agreement with theoretical predictions.

For more complete validation beyond a specific material set, a fabricator may grow a different TMD structure including WSe₂/ZnSe/WSe₂ heterostructures by molecular beam epitaxy. The use of the different TMD and buffer materials may demonstrate the capability of all in-situ and wafer-scale growth of NPLA heterostructures, without the need for exfoliation and layer transfer. Additionally, as ZnSe is a cubic 3D material in the zincblende phase, the properties of ZnSe may illustrate that the decoupling interlayer need not be a 2D material or even hexagonal. An observer may determine that the test results for the WSe₂/ZnSe/WSe₂ heterostructure also show a similar A enhancement (not shown in FIGS. 5A-5E). The observer may determine that the theoretical and experimental results demonstrate that an atomic buffer layer can be an effective strategy to A enhancement, for the TMD structures of this disclosure.

For the structure of this disclosure either twisting or inserting a buffer layer may be desirable, depending on purpose. In principle, it may be possible to combine these two methods. The absorbance of twisted and buffer layer system may be about the same as with a buffer layer structure.

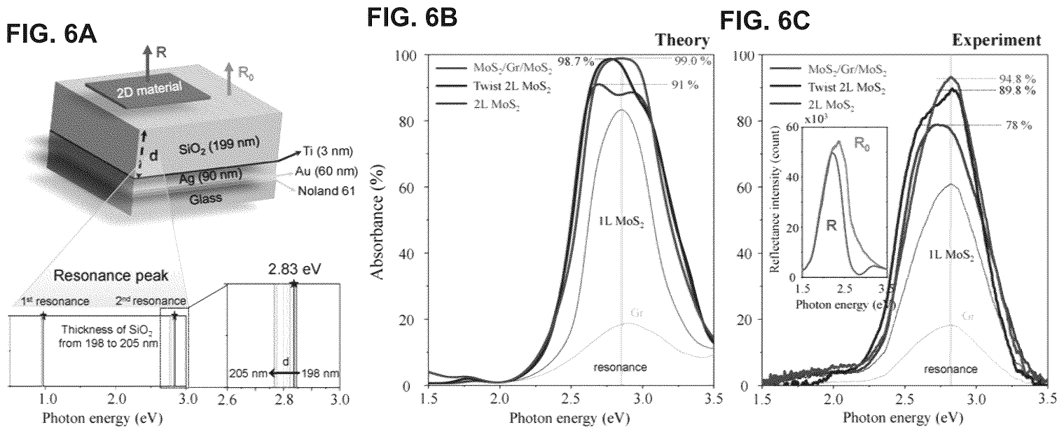

FIGS. 6A-6C illustrate an example realization of near-perfect light absorbers using the Salisbury screen and 2D material of this disclosure. FIG. 6A is a conceptual diagram illustrating the Salisbury screen structure described above, e.g., in relation to FIGS. 1A-3C. In the example of FIG. 6A, the thickness of the SiO₂ dielectric layer is illustrated as 199 nm, which may satisfy the coupling condition for the photon energy of the C exciton (e.g., 2.83 eV in the example of FIG. 6A). In other examples, the approaches of this disclosure may tune the optimum wavelength for a desired NPLA by optimizing the thickness (d) of the dielectric layer, and thus the approaches of this disclosure may be easily adapted to the other material systems and desired wavelengths.

FIG. 6B is a graph illustrating the calculated absorbance spectra and FIG. 6C is a graph illustrating the experimentally measured absorbance spectra of various MoS₂ structures with Salisbury screen. In FIG. 6C, absorbance can be obtained from 1−R/R₀, where R and R₀ are the reflectances of the substrate with and without the 2D heterostructure, and the inset shows the raw data of reflectances for MoS₂/Gr/MoS₂ heterostructures.

FIG. 6A illustrates the geometry of the proposed twisted 2L MoS₂ and MoS₂/buffer layer/MoS₂ heterostructures with Salisbury screen structure composed of SiO₂ dielectric layer and Ag reflector. In the example of FIGS. 6A-6C, the thickness of the SiO₂ was chosen to be 199 nm. FIG. 6B represents the theoretically calculated A of various MoS₂ structures. Because of resonance effects near the C exciton peak, an observer may determine that A appears to enhance even in 1L Gr and 1L MoS₂. Also, the observer may calculate the theoretical maximum A of 2L MoS₂ as 91.0%, which may be further enhanced to 98.7% by using 32.22° twist angle. Theoretical calculations may show that A can increase up to 98.8% and 99.0% by using hBN and graphene buffer layers, respectively.

To validate theoretical prediction by experiments, a fabricator may fabricate, in a lab, the SiO₂ (199 nm)/Ti (3 nm)/Ag (90 nm)/Au (60 nm) heterostructure on a glass substrate by the template stripping method and for performing optical measurements. FIG. 6C shows experimental results. In this structure, the Ag mirror may reflect almost all incident light (for visible) at 2.83 eV, as shown in the measured reflectance R, and displayed in the inset of FIG. 6C. An observer may obtain the absorption, A, from 1−R/R₀, where R and R₀ are the reflectances of the substrate with and without the 2D heterostructure, respectively, as described in FIG. 6A. Consistent with the theoretical calculation, an observer may determine that experimental results show a strong resonance peak even with just Gr, validating the precisely controlled thickness of the SiO₂ layer. The observer may determine that maximum absorbance of pristine 2L MoS₂ may be measured to be ˜78% with a mild redshift, which may be a slightly lower value than that of theory, but in general agreement with the theory. With a non-zero twist angle, the observer may determine that A reaches almost 89.8% at the resonance peak of 2.83 eV with 28° rotation angle, and A weakens when the rotation angle is further away from 30° (e.g., A=86.3% at 26°, 84.5% at) 23°. The fabricator may fabricate the rotation angle of the first and second TMD layers in the range of 28° to 31°.

Moreover, an observer may determine that A in the MoS₂/Gr/MoS₂ is even higher than that of twisted 2L MoS₂, and reaches up to 94.8%, a relatively high value for structure with thickness less than 2 nanometers (nm). The observer may determine that these results are a strong confirmation that reducing interlayer coupling is a very efficient and feasible strategy to enhance A in the multilayer TMDs of this disclosure. Thus, the techniques of this disclosure show that a simple and cost-effective NPLAs may be realized by combining 2D materials, with the approached described herein, and a single mirror cavity structure.

As additional background on the computation methods described in this disclosure, the first-principles calculations are based on density functional theory as implemented in Vienna ab initio simulation package (VASP). The electronic wavefunctions may be expanded by plane wave basis with kinetic energy cutoff of 400 eV. For further calculations, an observer may employ projector-augmented wave pseudopotentials to describe the valence electrons and treated exchange-correlation (XC) functional within the generalized gradient approximation of Perdew-Burke-Ernzerhof (PBE). In addition, an observer may employ Grimme-D3 method to describe van der Waals interaction. To mimic layered structure in periodic cells, the observer may include, in calculations, a sufficiently large vacuum region in-between neighboring cells along the out-of-plane direction. A fabricator may construct the supercell structures for twisted 2L MoS₂ and MoS₂/Gr or hBN/MoS₂ heterostructures by the coincidence lattice method to minimize artificial strain within reasonable cell size. The observer may sample the Brillouin zone using 21×21×1, 7 15×15×1, and 9×9×1 k-point meshes for unit cell, MoS₂/Gr or hBN/MoS₂ heterostructure and twisted 2L MoS₂, respectively.

The observer may calculate the frequency-dependent optical conductivity σ(ω) by a Kubo-Greenwood formula defined as in the below equation:

$${σ}_{α β} ( h ω ) = \frac{i {e}^{2} h}{{N}_{k} {Ω}_{c}} {\sum }_{k} {\sum }_{n , m} \frac{{f}_{mk} - {f}_{nk}}{{ε}_{mk} - {ε}_{nk}} \frac{( {ψ}_{nk} \vert {v}_{α} \vert {ψ}_{mk} ) ( {ψ}_{mk} \vert {v}_{β} \vert {ψ}_{nk} )}{{ε}_{mk} - {ε}_{nk} - ( h ω + i η )} \qquad [ 3 ]$$

where a and B are Cartesian directions, NA is the number of k-points, Qc is the volume of the cell structure including vacuum region. Physically, the observer may determine that the quantitative value of σ′ strongly depends on the carrier relaxation time contributed from various scattering sources and temperatures. To deal with this quantity in the Kubo formula, the observer may use calculations as including a constant broadening parameter of n chosen to be 100 meV. The observer may use Wannier package to perform numerical calculations for σ(ω). The wannierization may use d and p orbital projections for transition metals and chalcogenides, respectively. The observer may calculate 2D optical conductivity σ_{2D}(ω) as σ_{2D}(ω)=σ(ω)L, where L is the out-of-plane lattice constant of periodic cell structure including the vacuum region.

In some examples, for the lab testing, a fabricator may fabricate large scale MoS₂ using Au-assisted exfoliation techniques. In some examples, at the first step, the fabricator may deposit a highly polished (111) bare Si wafer with a 150 nm thick Au film as an ultra-flat template by e-beam evaporation (e.g., using equipment such as the CHA industries, SEC 600). On top of the Au layer, the fabricator may spin-coat polymethyl methacrylate (e.g., from MicroChem, 950 PMMA C4) as a protecting layer at a rate of 1000 rpm for 60s. After baking at 120° C. for two minutes, the fabricator may peel off the Au layer from the Si substrate. The fabricator may then press a cleaved layered bulk MoS₂ on a freshly Au film to establish large-scale MoS₂/Au contact. The several hundred microns lateral monolayer MoS₂ may be peeled off due to the interaction between Au and the sulfur atom of MoS₂, which may be stronger than the interlayer vdW interaction in bulk MoS₂.

The fabricator may exfoliate the template-stripped Au and transfer the MoS₂/Au film/PMMA with a tape to the desired substrate. The fabricator may dip the layer in acetone to dissolve the PMMA and to peel off the tape. The fabricator may rinse the acetone residue with 2-propanol to remove the acetone residue. Finally, the fabricator may remove the top Au film by aqueous KI/I2 etchant (e.g., from Sigma Aldrich, “Au etchant, standard”) to release the MoS₂. To wash off Au etchant residues, the fabricator may rinse the MoS₂ on the Si substrate with acetone and 2-propanol and blown dry with nitrogen.

For the lab testing samples, in some examples, the Salisbury screen structure, e.g., using SiO₂ as an optical spacer, may be produced with the following techniques. A fabricator may heat a bare silicon wafer, e.g., on a hot plate at 180° C. for 5 min and then surface treat by oxygen plasma (e.g., using the Advanced vacuum, Vision 320) for 5 min. The silicon wafer may be deposited with a 60-nm-thick Au film as a sacrificial layer by an electron-beam evaporator (e.g., with the CHA industries, SEC 600). Plasma-enhanced chemical vapor deposition may deposit the SiO₂ layer as a dielectric spacer, in some examples, at 199 nm thick, by (e.g., with a Plasma-Therm, PECVD). The fabricator may deposit Ag and Au film at 90 nm and 60 nm thick, respectively, by electron-beam evaporation (e.g., with the CHA industries, SEC 600).

Next, the template stripping method may use a photocurable epoxy (such as from Norland, NOA 61) as an adhesive to transfer the entire cavity structure to a glass substrate. Finally, the fabricator may remove the sacrificial layer of the top Au using Au etchant (e.g., from Sigma Aldrich) to obtain a flat surface of SiO₂ on the bottom Ag mirror.

FIGS. 7A-7C illustrate near-perfect light absorbers over a wide frequency by using various TMD materials. In some examples, adjusting the dielectric layer for the specific application, e.g., desired wavelengths to be absorbed, may tune the NPLA to meet the desired performance.

One of the drawbacks of many other examples of optical resonance systems is that they may require precisely designed complex structures depending on the optimum wavelength. However, in approaches of this disclosure, the optimum wavelength may be tuned by simply optimizing the thickness of the dielectric layer and thus can be easily adapted to the other material systems. FIGS. 7A-7C may expand the techniques of this disclosure described above in relation to FIGS. 1A-6C to a wider family of materials. The examples of FIGS. 7A-7C illustrate the results of investigations of the optical conductivities and A of various 2D materials, whose operating wavelength appears in the visible region. FIG. 7A illustrates the calculated A of a total of twenty-nine 1L 2D materials embedded in the Salisbury screen, which cover the entire visible light spectrum. In the 1L limit, the highest A value was calculated to be 82.5% for MoS₂, followed by 2H-CrTe₂ (79.9%), and 2H-WS₂ (77.7%). FIG. 7B illustrates the results of using a 2L structure. FIG. 7B illustrates higher A for all materials, but these values may still be appreciably lower than unity, which may be desirable for NPLA. Finally, FIG. 7C illustrates that when an intermediate buffer layer is used, the result may be a clearly enhanced A for most materials, implying that reducing interlayer coupling generally increases A of a wide range of 2D materials. In addition to MoS₂, the other materials that may exhibit the strong absorption are 2H-CrTe₂ (97.9%), 2H-WS₂ (96.4%), and 2H-CrTe₂ (95.8%). Therefore, the chemical variety of 2D materials may open a possibility to realize atomically thin NPLAs for the entire visible light range.

The techniques of this disclosure demonstrate, through harnessing the full effect of band nesting, the ultimate Salisbury screen with only two uniform atomic layers of TMDs. The first-principles calculations may reveal that the interlayer coupling may have a detrimental effect on the degree of band nesting. To optimize band nesting and enhance absorption, this disclosure describes two approaches, (1) the twisted 2L MoS₂ and (2) MoS₂/Gr/MoS₂ heterostructure and observed strong absorption enhancement. As noted above, in other examples, different materials may be used for the TMD layer and the buffer. Through this strategy, without any complex optical structures, the techniques of this disclosure may realize NPLA with absorption as high as 95% using only simple single mirror reflector structure. The results of FIGS. 7A-7C may further confirm the strategies for optimizing band nesting are widely adaptable to the other 2D materials, offering an attractive and scalable platform for NPLAs across the visible spectrum.

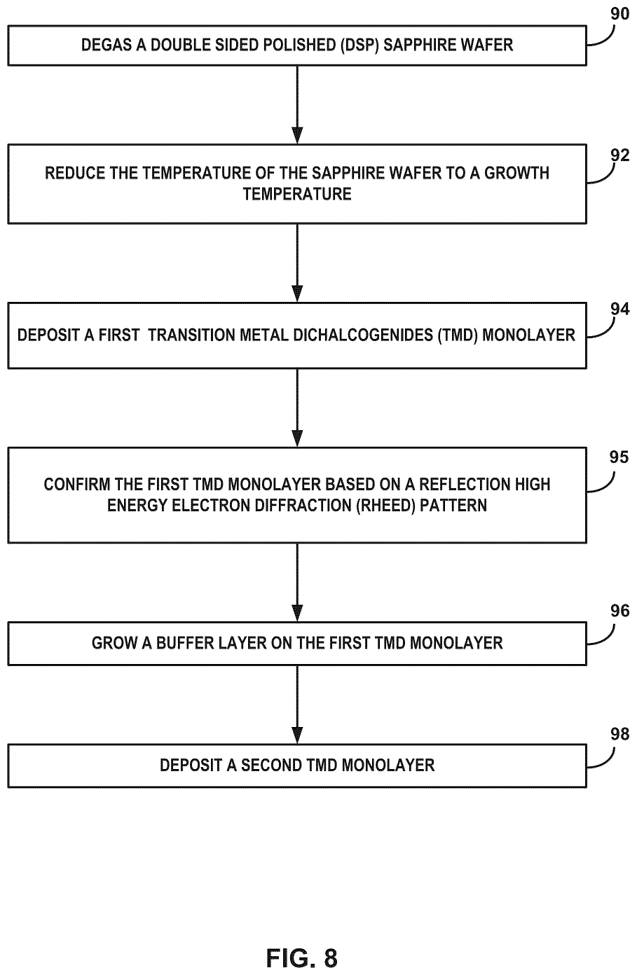

FIG. 8 is a flow chart illustrating a method of manufacture for an example optical resonator of this disclosure. As described above in relation to FIGS. 5A-5E, similar to the twisted case, in some examples, the TMD heterostructure with a buffer layer may be fabricated by a multi-step transfer process.

Gold (Au)-assisted 2D exfoliation is a promising technique that may overcome the limitations of conventional exfoliation methods and may enable the large-scale and high-quality fabrication of 2D materials. In this process, Au-assisted 2D exfoliation may improve the yield and efficiency of the exfoliation process and enable a monolayer TMD with a size of as large as a centimeter. Through the 2D transfer process, a fabricator may complete the structure by sequentially stacking the buffer layer and the TMD.

For the example of a buffer layer structure comprising WSe₂/ZnSe/WSe₂, in some examples, a fabricator may grow the heterostructure on a double side polished (DSP) sapphire (0001) wafer using molecular-beam epitaxy (MBE), which is an epitaxy method used for example, for thin-film deposition of single crystals. In some examples, the fabricator may first degas the sapphire, e.g., at 900° C. for specified time, such as 60 minutes (90). The fabricator may ramp down the temperature of the sapphire down to the growth temperature of 600° C. using a ramp rate such as 30° C./min (92).

In some examples, the fabricator may start the growth process with the deposition of the bottom WSe₂ monolayer (ML) by co-depositing tungsten (W), evaporated using a multi-pocket e-beam evaporator, and elemental selenium (Se), evaporated using a cracker source (94). A tungsten to selenium flux ratio of 1:200 may be desirable for this process. The fabricator may obtain W flux (˜5×10⁻⁹ mbar) using an e-beam current of 200 mA and voltage of approximately 6 kV. The fabricator may control the Se flux (1×10⁻⁶ mbar) by setting the temperature of the Se reservoir to 130° C. and its cracker tip to 1100° C. The fabricator may use WSe₂ growth rate at approximately one ML/6 hours. The fabricator may confirm the first TMD monolayer based a reflection high energy electron diffraction (RHEED) pattern (95). The fabricator may confirm ML coverage in some examples, by the disappearance of the RHEED pattern of the sapphire substrate and the concomitant appearance of a new RHEED pattern corresponding to the WSez. For example, the fabricator may confirm the growth of the first TMD monolayer following the deposition of the tungsten and the selenium and observing one or more changes in the RHEED pattern.

The fabricator may grow the buffer layer, I., of one nm ZnSe at approximately 600° C., in some examples, in the same chamber with the zinc (I., cell temperature: 320° C., flux: 2×10⁻⁶ mbar) and selenium (I., cell temperature: 190° C., flux: 2×10⁻⁷ mbar) co-evaporated using low-temperature Knudsen cells. A fabricator may find a zinc to selenium flux ratio of 10:1 as desirable. The fabricator may grow the top ML of WSe₂ may at, also at about 600° C. on this ZnSe template using the same W e-beam evaporator and Se cracker source. The fabricator may avoid post-growth annealing to also avoid any high temperature degradation of the bottom layers.

To fabricate the optical cavity, the fabricator may remove the sample from the MBE, move the sample to a plasma enhanced chemical vapor deposition (PECVD) chamber, and cap the sample with approximately 192 nm of SiO₂ deposited at about 250° C. The specific thickness of 192 nm may be desirable to satisfy the “critical coupling condition” for the photon energy of 2.92 eV (B′ exciton peak of Wse₂). Lastly, the fabricator may deposit a three nm of titanium (adhesion layer) followed by 100 nm of silver using e-beam evaporation to be used as the back reflector.

The techniques of this disclosure may also be described in the following examples.

Example 1A. A device comprising: a stack of monolayer transition metal dichalcogenides (TMD) material comprising a first TMD monolayer arranged in the stack with a second TMD monolayer, wherein the stack of monolayer TMDs is configured to absorb light, wherein an arrangement of the first TMD monolayer and the second TMD monolayer is configured to alleviate interlayer coupling between the first TMD monolayer and the second TMD monolayer and thereby result in a light absorption of greater than 90%.

Example 2A. The device of example 1A, wherein the first TMD monolayer and the second TMD monolayer are each two-dimensional (2D) materials.

Example 3A. The device of example 1A, further comprising dielectric spacer and a reflective mirror arranged with the stack of monolayer TMDs in a Salisbury screen configuration.

Example 4A. The device of example 1A, wherein the arrangement of the first TMD monolayer and the second TMD monolayer comprises a parallel planar arrangement as twisted bilayer with a rotation angle of the first TMD monolayer relative to the second TMD monolayer.

Example 5A. The device of example 4A, wherein the rotation angle is in the range of 28° to 31°.

Example 6A. The device of any of examples 1A-3A, wherein the stack of monolayer TMDs further comprises a buffer layer arranged as a parallel plane between the first TMD monolayer and the second TMD monolayer.

Example 7A. The device of example 6, wherein buffer layer is selected from a group of materials consisting of: graphene (Gr), Zinc selenide (ZnSe), or hexagonal boron nitride (hBN).

Example 8A. The device of example 6, wherein the buffer layer is a material comprising carbon.

Example 9A. The device of any of examples 1A-8A, wherein the TMD material is selected from a group of materials consisting of MoS₂, Wse₂, and CrTe₂.

Example 10A. The device of any of examples 1A-9A, wherein the device is an optical resonator.

Example 11A. The device of any of examples 1A-10A, wherein the device is a near perfect light absorber (NPLA).

Example 12A. The device of any of examples 1A-11A, wherein to control interlayer coupling comprises to alleviate interlayer coupling, wherein interlayer coupling induces bonding and anti-bonding states between two layers, resulting in the degradation of the band nesting.

Example 13A. The device of any of examples 1A-12A, wherein to alleviate interlayer coupling comprises to increase interlayer distance and thus decrease interlayer interaction.

Example 14A. A method comprising: degassing a double sided polished (DSP) sapphire wafer; reducing, the temperature of the sapphire wafer to a growth temperature; depositing a first transition metal dichalcogenides (TMD) monolayer; confirming the first TMD monolayer; growing a buffer layer on the first TMD monolayer; depositing a second TMD monolayer.

Example 15A: The method of example 14A, further comprising: depositing a layer of silicon dioxide using plasma enhanced chemical vapor deposition (PECVD) chamber; adding an adhesion layer to the silicon dioxide layer; depositing a reflector layer by e-beam evaporation.

Example 1: A device includes a stack of monolayer transition metal dichalcogenides (TMD) material includes the first TMD monolayer and the second TMD monolayer comprise a planar arrangement as a twisted bilayer with a rotation angle of the first TMD monolayer relative to the second TMD monolayer; or the first TMD monolayer and the second TMD monolayer are separated by a buffer layer.

Example 2: The device of example 1, wherein the stack of monolayer TMDs is configured to absorb light with a light absorption of greater than 90%.

Example 3: The device of any of examples 1 and 2, wherein the first TMD monolayer and the second TMD monolayer are each two-dimensional (2D) materials.

Example 4: The device of any of examples 1 through 3, further comprising a dielectric spacer and a reflective mirror arranged with the stack of monolayer TMDs in a Salisbury screen configuration.

Example 5: The device of any of examples 1 through 4, wherein the first TMD and the second TMD are parallel to one another.

Example 6: The device of any of examples 1 through 5, wherein the rotation angle is in the range of 28° to 31°.

Example 7: The device of any of examples 1 through 6, wherein the buffer layer is a parallel plane between the first TMD monolayer and the second TMD monolayer.

Example 8: The device of any of examples 1 through 7, wherein the buffer layer separates the first TMD monolayer and the second TMD monolayer by less than or equal to 0.01 micron.

Example 9: The device of any of examples 1 through 8, wherein the stack of monolayer TMDs is configured to absorb light having a wavelength between 100 nm and 1 mm.

Example 10: The device of any of examples 1 through 9, wherein the stack of monolayer TMDs is configured to absorb light having an optical wavelength, and wherein the buffer layer separates the first TMD monolayer and the second TMD monolayer by a distance that is less than one-hundredth of the optical wavelength.

Example 11: The device of any of examples 1 through 10, wherein at least one of the first TMD monolayer or the second TMD monolayer is electrically biased to modify carrier concentration of the one of the first TMD monolayer or the second TMD monolayer.

Example 12: The device of any of examples 1 through 11, wherein the buffer layer is optically inactive with relatively low optical absorption at an optical wavelength or optical wavelength range at which the stack of monolayer TMDs is configured to absorb light.

Example 13: The device of any of examples 1 through 12, wherein buffer layer is selected from a group of materials consisting of: graphene (Gr), Zinc selenide (ZnSe), or hexagonal boron nitride (hBN).

Example 14: The device of any of examples 1 through 13, wherein the buffer layer is a material comprising carbon or an air gap layer.

Example 15: The device of any of examples 1 through 14, wherein the TMD material is selected from a group of materials consisting of MoS₂, Wse₂, and CrTe₂.

Example 16: The device of any of examples 1 through 15, wherein the device is an optical resonator.

Example 17: The device of any of examples 1 through 16, wherein the device is a near perfect light absorber (NPLA).

Example 18: The device of any of examples 1 through 17, wherein a thickness of the first TMD monolayer is a minimum thickness of a chemical structure of a combination of elements that form the first TMD monolayer, and wherein a thickness of the second TMD monolayer is a minimum thickness of a chemical structure of a combination of elements that form the second TMD monolayer.

Example 19: The device of any of examples 1 through 18, wherein a thickness of the first TMD monolayer is a minimum thickness where the molecules of the first TMD monolayer are covalent bonded, and wherein a thickness of the second TMD monolayer is a minimum thickness where the molecules of the second TMD monolayer are covalent bonded.

Example 20: A method includes degassing a double sided polished (DSP) sapphire wafer; reducing, the temperature of the sapphire wafer to a growth temperature; depositing a first transition metal dichalcogenides (TMD) monolayer; confirming the first TMD monolayer; growing a buffer layer on the first TMD monolayer; and depositing a second TMD monolayer.

Various examples of the disclosure have been described. These and other examples are within the scope of the following claims.

What is claimed is:

1. A device comprising:
a stack of monolayer transition metal dichalcogenides (TMD) material comprising a first TMD monolayer arranged in the stack with at least a second TMD monolayer,
wherein the stack of monolayer TMDs is configured to absorb light, and
wherein at least one of:
the first TMD monolayer and the second TMD monolayer comprise a planar arrangement as a twisted bilayer with a rotation angle of the first TMD monolayer relative to the second TMD monolayer; or
the first TMD monolayer and the second TMD monolayer are separated by a buffer layer.

2. The device of claim 1, wherein the stack of monolayer TMDs is configured to absorb light with a light absorption of greater than 90%.

3. The device of claim 1, wherein the first TMD monolayer and the second TMD monolayer are each two-dimensional (2D) materials.

4. The device of claim 1, further comprising a dielectric spacer and a reflective mirror arranged with the stack of monolayer TMDs in a Salisbury screen configuration.

5. The device of claim 1, wherein the first TMD and the second TMD are parallel to one another.

6. The device of claim 1, wherein the rotation angle is in the range of 28° to 31°.

7. The device of claim 1, wherein the buffer layer is a parallel plane between the first TMD monolayer and the second TMD monolayer.

8. The device of claim 1, wherein the buffer layer separates the first TMD monolayer and the second TMD monolayer by less than or equal to 0.01 micron.

9. The device of claim 1, wherein the stack of monolayer TMDs is configured to absorb light having a wavelength between 100 nm and 1 mm.

10. The device of claim 1, wherein the stack of monolayer TMDs is configured to absorb light having an optical wavelength, and wherein the buffer layer separates the first TMD monolayer and the second TMD monolayer by a distance that is less than one-hundredth of the optical wavelength.

11. The device of claim 1, wherein at least one of the first TMD monolayer or the second TMD monolayer is electrically biased to modify carrier concentration of the one of the first TMD monolayer or the second TMD monolayer.

12. The device of claim 1, wherein the buffer layer is optically inactive with relatively low optical absorption at an optical wavelength or optical wavelength range at which the stack of monolayer TMDs is configured to absorb light.

13. The device of claim 1, wherein buffer layer is selected from a group of materials consisting of: graphene (Gr), Zinc selenide (ZnSe), or hexagonal boron nitride (hBN).

14. The device of claim 1, wherein the buffer layer is a material comprising carbon or an air gap layer.

15. The device of claim 1, wherein the TMD material is selected from a group of materials consisting of MoS₂, Wse₂, and CrTe₂.

16. The device of claim 1, wherein the device is an optical resonator.

17. The device of claim 1, wherein the device is a near perfect light absorber (NPLA).

18. The device of claim 1,
wherein a thickness of the first TMD monolayer is a minimum thickness of a chemical structure of a combination of elements that form the first TMD monolayer, and
wherein a thickness of the second TMD monolayer is a minimum thickness of a chemical structure of a combination of elements that form the second TMD monolayer.

19. The device of claim 1,
wherein a thickness of the first TMD monolayer is a minimum thickness where the molecules of the first TMD monolayer are covalent bonded, and
wherein a thickness of the second TMD monolayer is a minimum thickness where the molecules of the second TMD monolayer are covalent bonded.

20. A method comprising:
degassing a double sided polished (DSP) sapphire wafer;
reducing, the temperature of the sapphire wafer to a growth temperature;
depositing a first transition metal dichalcogenides (TMD) monolayer;
growing a buffer layer on the first TMD monolayer; and
depositing a second TMD monolayer.
